(19) United States
(12) Patent Application Publication
(10) Pub. No.: US 2008/0022693 A1
(43) Pub. Date: Jan. 31, 2008

(54) Ceramic blade gas turbine

(76) Inventor: Zoran Dicic, Ardsley, NY (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/504,842

(22) Filed: Aug. 16, 2006

Related U.S. Application Data
(60) Provisional application No. 60/722,192, filed on Sep. 30, 2005.

(51) Int. Cl. F02C 3/04

(52) U.S. Cl. 60/805

(57) ABSTRACT

A rotor assembly for use in a turbine that has a rotor supported in a turbine compressor casing of the turbine for rotational movement of the rotor about a rotor axis. The rotor assembly comprises a first gas flow assembly positioned within the turbine compressor casing and around the rotor. The first gas flow assembly has a plurality of nozzles that are removeably attached to an inner circumference of the rotor, each nozzle having a nozzle inlet, a nozzle outlet and a nozzle blade disposed there between. The rotor assembly further comprises a heat assembly partially positioned within the turbine compressor casing of the rotor. The heat assembly directs heated gas into the nozzle inlet wherein the nozzle outlets discharge the heated gas tangentially with respect to the rotor such that the discharged heated gas produces a reactive force on the plurality of nozzles to rotate the rotor about the rotor axis. The rotor assembly also comprises a second gas flow assembly positioned on the inner circumference of the rotor and positioned adjacent to the first gas flow assembly. The second gas flow assembly has a plurality of stationary blades fixedly supported on the heat assembly and having a plurality of rotary blades removeably attached to the inner circumference of the rotor.

### CROSS-REFERENCE TO RELATED APPLICATIONS

This application claims priority under 35 U.S.C. § 119(e) of U.S. Provisional Patent Application No. 60/722,192 filed Sep. 30, 2005, in the name of the present inventor and entitled “Ceramic Gas Turbine”.

### STATEMENT REGARDING FEDERALLY SPONSORED RESEARCH

Not Applicable.

### BACKGROUND OF THE DISCLOSURE

The present disclosure relates to an assembly and method for rotating a rotor within a turbine casing, and in particular, an assembly in which rotating components such as nozzles and blades experience primarily compressive stress during operation of the rotor, while the components withstand high temperatures during operation of the turbine.

The performance and efficiency of a gas turbine depend on the temperature at which a hot combustion gas injects through a turbine gas inlet, following which the hot gas expands in successive turbine stages including sets of rotary nozzles and sets of fixed and rotary turbine blades. These nozzles and fixed and rotary blades are positioned on the outer circumference of the rotor. The turbine achieves adequate power and efficiency only with the use of materials capable of withstanding high temperatures experienced by the components (e.g., nozzles and blades) in the path of the hot gas. These components are therefore very costly because of their material composition and the technology applied in their manufacture.

Turbine components disposed in the path of the hot combustion gas are usually made from metallic compositions including nickel, chromium and cobalt in ranges up to 60% each for a particular material application with minor percentages of iron and/or certain alloys. While the components require exotic materials in order to withstand high temperature environments, complex arrangements must also be employed for cooling of these components. For example, conventional turbines cool the heated components by applying air taken from the compressor. This rerouted compressor air results in loss of power and impacts efficiency. Additionally, these foregoing factors contribute to high costs for the operation and maintenance of turbine power plants.

An alternative to metallic materials comprises ceramic materials. The advantages of ceramic materials result from their stable performance at high temperatures, good load bearing ability, high strength in compression, thermal and dimensional stability and chemical resistance. However, application of ceramics for components in present gas turbine configurations results in problems owing to limitations with respect to mechanical properties of the ceramic materials: brittleness, very low bending strength and tension, and low impact resistance and fracture toughness.

Gas turbines, using ceramic materials, have been produced as one-piece radial turbines for various applications. The efficiency for these gas turbines, however, is low and the applications found place in distributed generation in co-geneneration for small projects.

Another application of ceramics involved coating metallic blades and other metallic turbine components in order to prolong the life of the components under high temperature operating conditions. For these applications, disadvantages of ceramics include susceptibility to fracture, and lack of sufficient tensile strength to withstand the operating stresses typically encountered by rotary turbine blades. Because the rotary blades are conventionally mounted on the outer circumference of a cylindrical rotor that spins typically from 3000 rpm to tens of thousands rpm or higher during turbine operation, extremely high tensile stresses develop in the blades and blade mounts due to centrifugal force. In these conventional turbines, roots set the rotating blades in the outer circumference rotor, and the blades are exposed to high centrifugal forces, i.e. tension, which is a weakness that prohibits ceramic blade application. Accordingly, rotary blades using ceramics are susceptible to failure if used in conventional high-speed turbine configurations, i.e. rotary blades mounted on the outer circumference of the rotor. Thus, efficient turbines require configurations in which the rotary ceramic components undergo primarily compressive rather than tensile stress during operation of the rotor and in which the components withstand the high temperatures applied during turbine operation.

### BRIEF SUMMARY OF THE DISCLOSURE

Briefly stated, the present disclosure relates to an assembly in which rotating components comprised of ceramic materials experience primarily compressive stress during operation of a rotor of a turbine.

In the present disclosure, the turbine casing supports the rotor of the turbine for rotational movement of the rotor about a rotor axis. The assembly comprises a first gas flow assembly positioned on an inner circumference of the rotor, the first gas flow assembly having a plurality of nozzles that are removeably attached to the inner circumference of the rotor. Each nozzle has a nozzle inlet, a nozzle outlet and a nozzle blade disposed there between. The assembly additionally comprises a second gas flow assembly positioned on the inner circumference of the rotor and positioned adjacent to the first gas flow assembly, the second gas flow assembly having a plurality of stationary blades fixedly supported on a heat assembly and having a plurality of rotary blades removeably attached to the inner circumference of the rotor. The assembly further comprises a cooling assembly that provides low-pressure fluid. The cooling assembly is partially positioned outside of the turbine casing and in fluid communication with the turbine casing. The cooling assembly has a fluid inlet, a fluid outlet and a fluid channel there between, the fluid channel being positioned around the first and the second gas flow assemblies to direct cooling fluid through a passage between the rotor and turbine casing.

Additionally, the assembly comprises a heat assembly partially positioned within the turbine casing. The heat assembly has a heat inlet positioned outside of the rotor, a heat outlet in communication with the nozzle inlet and a heat channel disposed between the heat inlet and the heat outlet. The heat assembly directs heated gas from the heat inlet to the heat outlet and radially into the nozzle inlet wherein the nozzle outlets discharge the heated gas tangentially with respect to the inner circumference of the rotor such that the discharged heated gas produces a reactive force on the nozzles to rotate the rotor about the rotor axis. The cooling assembly also provides cooling fluid for the heat assembly.

The foregoing and other objects, features, and advantages of the disclosure as well as presently preferred embodiments thereof will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 is a side cross sectional view of assemblies constructed in accordance with and embodying the present disclosure illustrating: a turbine system, a first gas flow assembly, at least one additional gas flow assembly, a heat assembly and a cooling assembly;

FIG. 1A is a cross sectional view taken along line “1A-1A” of FIG. 1;

FIG. 1B is a cross sectional view taken along line “1B-1B” of FIG. 1;

FIG. 1C is a cross sectional view taken along line “1C-1C” of FIG. 1;

FIG. 2 is a partial sectional view of a flow path of heated gas through the first gas flow assembly and at least one additional gas flow assembly of FIG. 1;

FIG. 3 is a schematic view illustrating the flow of heated gas and cooling fluid through the turbine system and associated assemblies of FIG. 1;

FIGS. 4A-4G are partial sectional views of components of the first gas flow assembly of FIG. 1 constructed in accordance with and embodying the present disclosure;

FIGS. 5A-5D are partial sectional views of stationary blades of at least one additional gas flow assembly of FIG. 1 constructed in accordance with and embodying the present disclosure illustrating stationary blades attached to the heat assembly;

FIGS. 6A-6D are partial sectional views of rotary blades of at least one additional gas flow assembly of FIG. 1 constructed in accordance with and embodying the present disclosure, the rotary blades being removeably attached to the inner circumference of the rotor;

FIGS. 7A-7C are partial sectional views of components of the heat assembly of FIG. 1; and

FIG. 8 is a side cross sectional view of another gas flow assembly constructed in accordance with and embodying the present disclosure.

Corresponding reference numerals indicate corresponding parts throughout the several figures of the drawings.

### DESCRIPTION OF THE PREFERRED EMBODIMENT

The following detailed description illustrates the disclosure by way of example and not by way of limitation. The description clearly enables one skilled in the art to make and use the disclosure, describes several embodiments, adaptations, variations, alternatives, and uses of the disclosure, including what is presently believed to be the best mode of carrying out the disclosure.

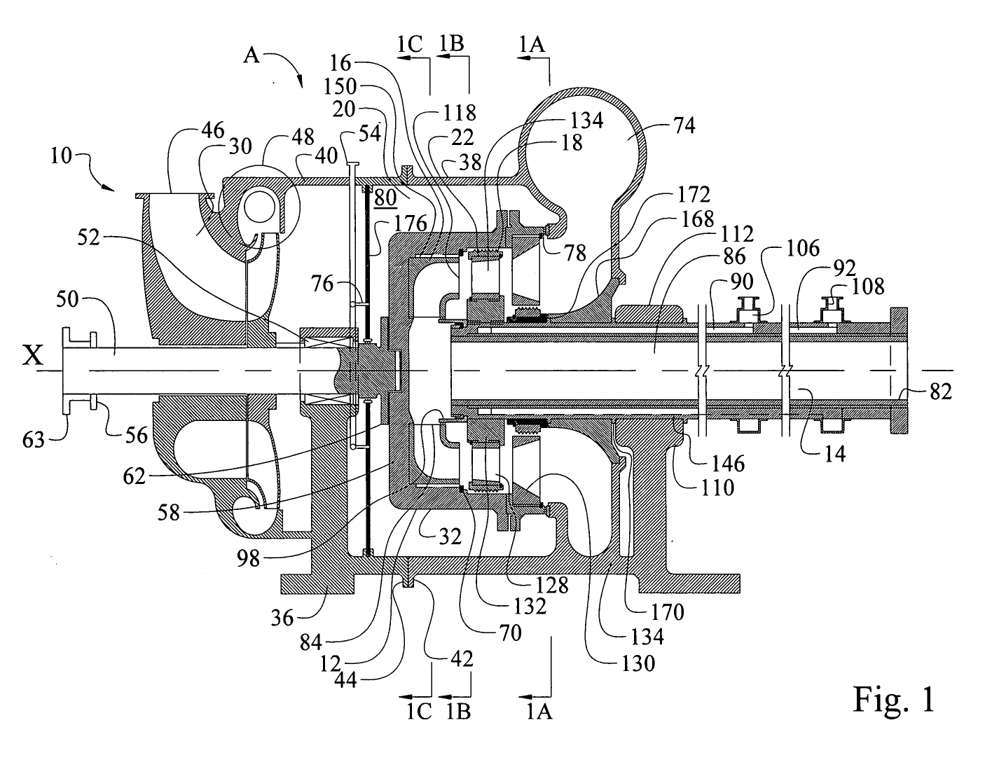

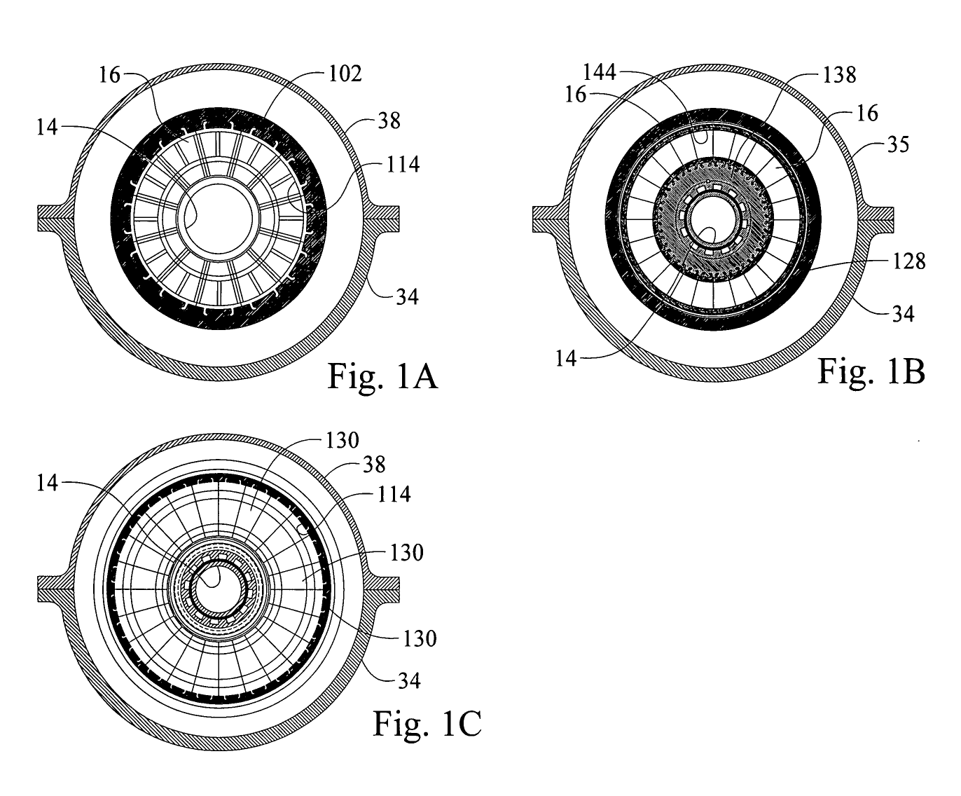

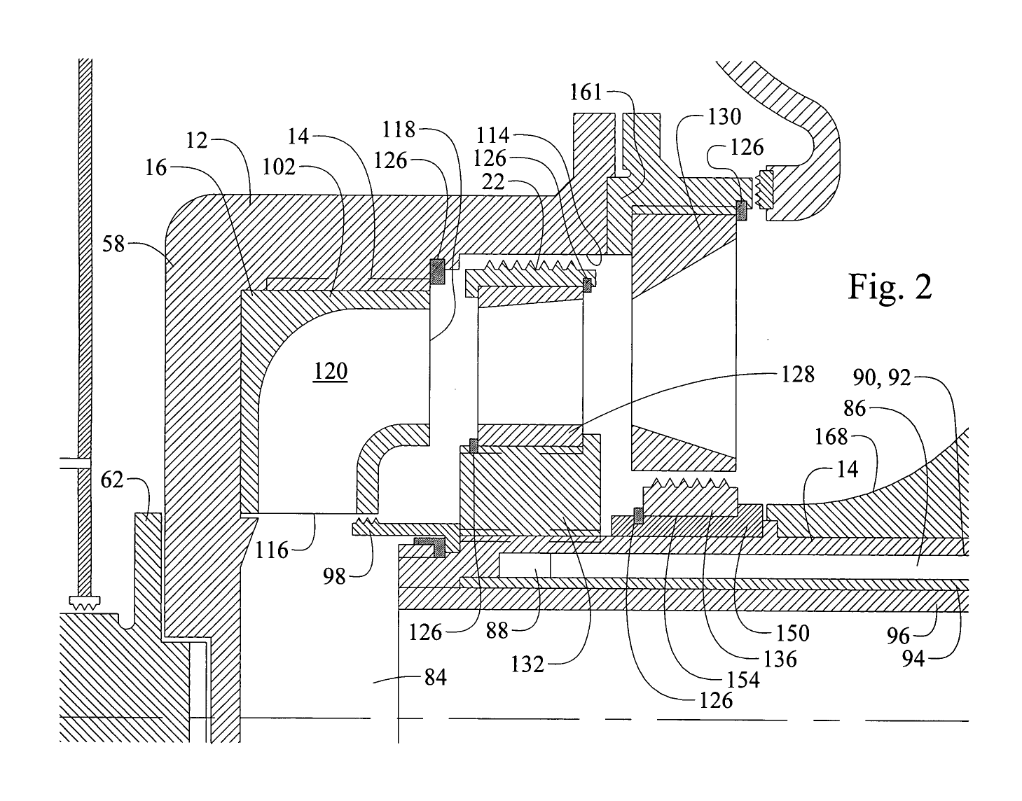

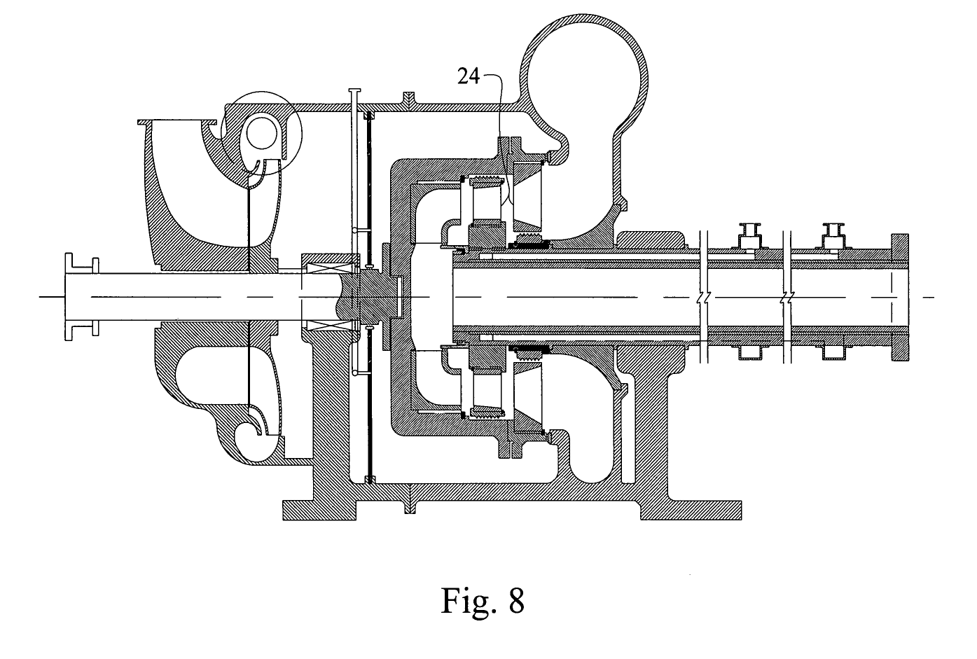

Referring to the drawings, a rotor assembly A for a turbine generally shown as 10 is shown (FIG. 1). The rotor assembly A assists in rotational movement of a rotor 12 (supported in a turbine casing of the turbine 10) about a rotor axis “X”. The rotor assembly A comprises a heat assembly generally shown as 14, a first gas flow assembly generally shown as 16, at least one additional gas flow assembly generally shown as 18 and a cooling assembly generally shown as 20. As shown in FIGS. 1 and 2, the at least one additional gas flow assembly 18 comprises a second gas flow assembly 22 in the form of a second stage cylindrical rotor section. The additional gas flow assembly 18 may also comprise a third gas flow assembly in the form of a third stage cylindrical rotor section generally shown as 24 in FIG. 8. As noted, the present disclosure comprises the rotor assembly A used in conjunction with the turbine system.

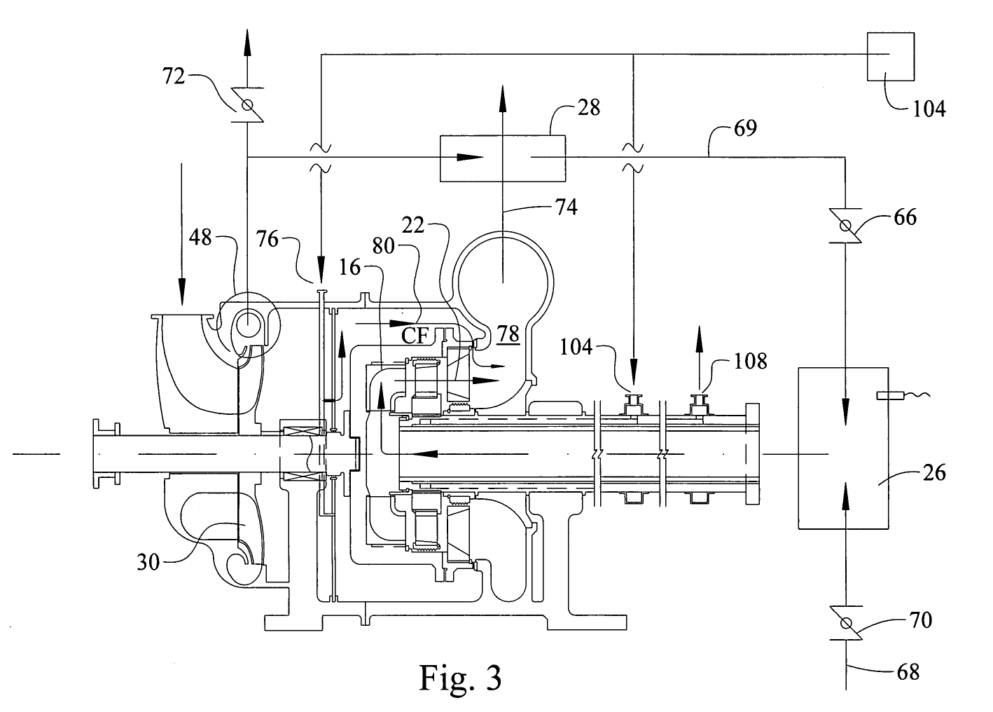

The turbine system comprises the turbine 10, a combustor 26 (FIG. 3), a heat exchanger 28 (FIG. 3) and a compressor 30 (FIG. 1). In one embodiment, the turbine 10 operates thermodynamically in accordance with the known Brayton cycle. Referring to FIG. 1, components of the turbine 10 are enclosed by a two-part, covered casing 32 including a hot casing 34, a cold casing 36, a hot casing top cover 38, and a cold casing top cover 40. The hot and the cold casings 34, 36 with their covers 38, 40 are bolted or otherwise joined in axial alignment to one another by way of mating flanges 42, 44. The cold casing 36 and its cover 40 form part of the compressor 30, including an air inlet 46 and an air outlet 48.

In the illustrated embodiment of FIG. 1, compressor 30 is a conventional single stage centrifugal compressor and is set concentric on a shaft 50. A bearing assembly 52 that is fixed inside the cold casing 36 supports the shaft 50 both axially and radially, and the shaft operatively drives the compressor 30. The compressor 30 is not limited to a single stage unit, however, and may have more than one stage to enhance power rating and efficiency as is known in the art. The cold casing 36 provides process air intake and air discharge along with a cooling inlet 54 of the cooling assembly 20 for cooling the rotor 12. The cooling inlet 54 is located along the cold casing 36 in order to cool the back of the turbine rotor disk and the shaft 50 to provide a thermal barrier to protect bearings assembly 52 from overheating. A cooling fluid is introduced by a plurality of inlet holes on a partition of a distribution ring. The cold casing 36 is flanged to the hot casing 34 wherein the casings are opened at the joint to permit cooling fluid flow into the hot casing 34. As such, the cold casing 36 is horizontally split.

The first gas flow assembly having rotary nozzles 16 and second gas flow assembly 22 having stationary and rotary blades are axially arranged from end to end and around the rotor 12. The nozzles and blades are removably attached to the inner circumference of the rotor hollow segments. Being attached to the inner circumference, the stress owing to the high-speed rotation is compression as opposite to the stress in conventional turbine configurations where the blades are attached to the outer circumference of the rotor and the basic stress in the blades is tension. The present disclosure can be used with conventional metallic materials; the advantage is owing to elimination of blade roots are not eliminated, however, the configuration mitigates stress problems associated with existing blade roots and associated stress problems. The present disclosure provides another advantage of the hollow rotor 12 with the rotary blades attached to the inner circumference of the rotor 12 and enabling low-pressure air for cooling purposes.

An outside portion of the shaft 50 couples to a start up drive gear 56 shown at the left in FIG. 1, and the opposite end of the shaft 50 connects to an axial end wall 58 of the hollow cylindrical turbine rotor 12 through a flange 62 that fixes coaxially on the shaft 50. A coupling 63 connects at the outside end of the shaft 50 to connect the turbine 10 to driven equipment (not shown), for example, a vehicle transmission, a boat propeller, or a generator.

Turning to FIG. 3, a combustion air conduit 64 communicates pressurized air from the outlet 48 of the compressor 30 through the regenerative heat exchanger 28 and an air control valve 66, to the external combustor 26. A fuel supply line 68 also communicates with the combustor 26 through a fuel control valve 70. An air relief valve 72 connects with the air conduit 64 from the compressor 30 for use during turbine start-up. Filtered air is taken from the outside, compressed and conveyed by the air conduit 64 to the external combustor 26. In order to improve efficiency, the heat exchanger 28 preheats the air before it enters the combustor 26. As schematically shown in FIG. 3, heat exchanger 28 is part of a turbine exhaust 74.

The combustor 26 may be in the form of a number of commercially available external combustors, and is preferably lined with ceramics. Use of the external combustor 26 has the advantage of allowing any kind of fuel presently used for gas turbines to be used to power the turbine 10. As such, the use of the external combustor 26 has the advantage of allowing the operator a choice among a number of different fuels. The combustor 26 may utilize staged combustion to minimize nitric oxide production. Start-up of the turbine 10 may involve a conventional outside drive arrangement to deliver air from the compressor 30 to the combustor 26, until a self-sustainable combustion is achieved. The speed required for start up is lower than normal operating turbine speed. Other controls may be conventional as are typically used with gas turbines.

As shown in FIG. 3, the rotor cooling assembly 20 is partially positioned outside the turbine casing 32 and in fluid communication with the turbine casing 32 via the cooling inlet 54 (FIG. 1) within the turbine casing 32. The cooling assembly 20 positions a fluid inlet 76, a fluid outlet 78 and cooling/fluid channel 80 there between. Channel 80 is formed by partition 174, end wall 58, rotors 16 and 22, casing 34 and hot casing cover 38. A fluid, such as air, is delivered through the distribution ring to inlet 76. The cooling assembly 20 may comprise an external low-pressure air source. As shown in FIG. 3, the channel 80 is positioned around the first gas flow assembly 16 and the second gas flow assembly 22. In other words, the fluid channel 80 is disposed between the rotor 12 and the casing 32 in order to cool the metal components of the rotor 12.

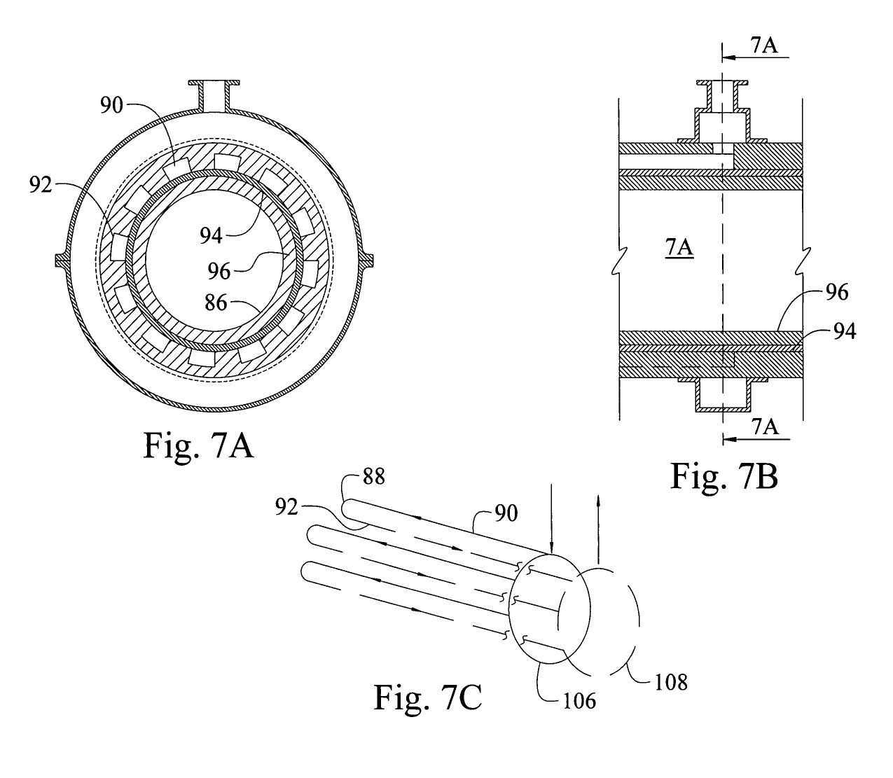

As shown in FIGS. 7A and 7C, the heat assembly 14 further comprises a plurality of cooling fluid channels 90, 92 in the form of arcuate channels 88 axially positioned inside the heat channel 86 (FIG. 7B). The heat channel 86 has a number of equi-circumferentially spaced axial grooves or channels formed in the inner circumference of the channel 86. Arcuate channels 88 communicate between adjacent axial channels near the heat outlet end 84 (FIG. 2) of the heat channel 86 so that when cooling fluid is applied under low pressure into a first set of axial channels 90 near the inlet end 82 of the heat assembly 14, the cooling fluid travels through the channels 90 to cool the assembly 14 and then returns to the inlet end 82 through a second set of axial channels 92 that are interleaved with the first set of axial channels 90. Referring to FIGS. 7A and 7B, a metallic insert tube 94 fits tightly inside the heat channel 86 and thus forms a closed bottom wall for each of the channels 90, 92 on the inner periphery of the heat channel 86. Furthermore, a ceramic liner tube 96 is fit tightly inside the metallic insert tube 94 and serves to protect the tube 94 from thermal corrosion. FIG. 7B illustrates the insert tube 94 and liner tube 96 in cross section.

As seen in FIGS. 3 and 7A-7C, the cooling fluid in the form of air from the low-pressure supply 104 enters the internal axial channels 90 of the heat channel 86 through an annular feeder 106. Air returned through the internal channels 92 of the heat channel 86 exits to an annular collector 108. The heat assembly 14 is fixed near its inlet end 82 on a hot casing tube support 110 (FIG. 1) by a tube support cover or clamp 112 (FIG. 1).

Returning to FIG. 1, the heat assembly 14 is supported and partially positioned within the turbine casing 32. The heat assembly 14 has a heat inlet 82 positioned outside the rotor 12, a heat outlet 84 in communication with the first gas flow assembly 16 and a heat channel 86 disposed between the heat inlet 82 and the heat outlet 84. The generally cylindrical heat assembly 14 positions inside the hot casing 34 to extend axially within the hollow cylindrical rotor 12. Hot gas originating from the combustor 26 is directed through the heat inlet 82 of the assembly 14, to be discharged from the outlet 84 of the assembly and to flow over a path in which the gas expands within successive stages inside of the turbine 10. As such, the heat assembly 14 directs the heated gas within the rotor 12.

An annular gas seal 98 (FIG. 2) is positioned position about the outlet end 84 of the heat assembly 14, to ensure that hot gas discharged from the outlet end 84 is directed with minimal leakage into the first gas assembly 16. As shown in FIG. 3, a flange at the inlet end 82 at the outside end of the heat assembly 14 connects the heat assembly 14 to the external combustor 26.

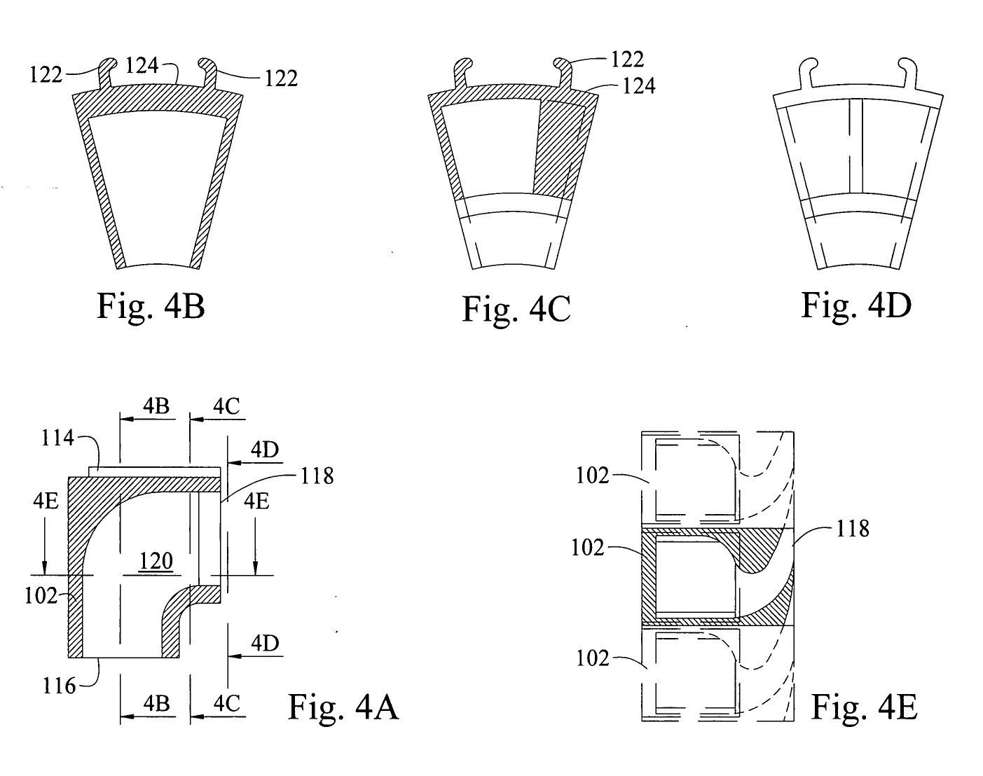

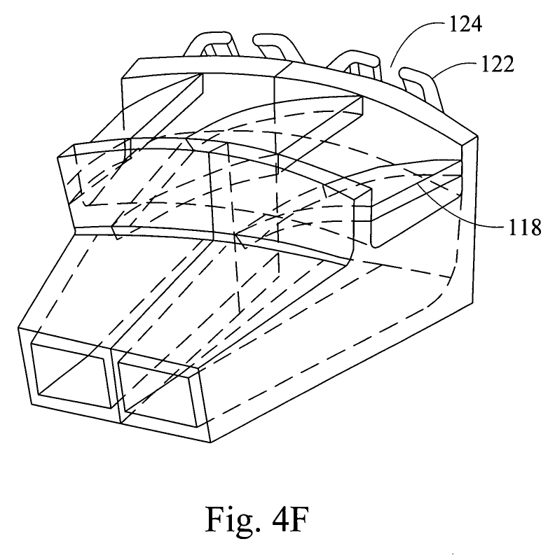

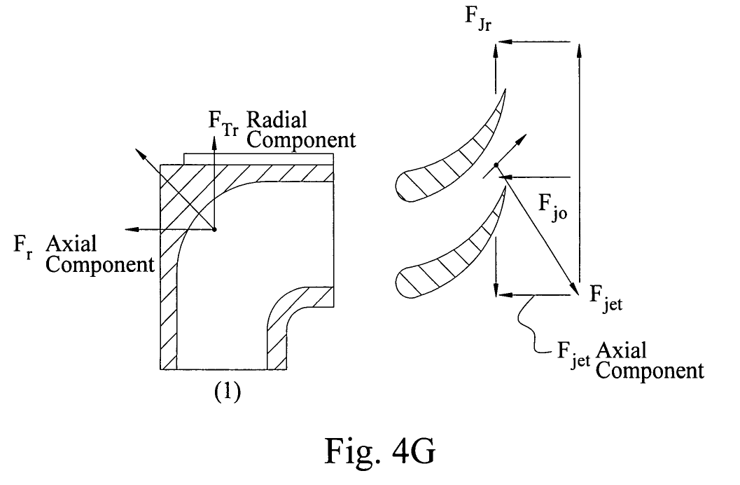

Returning to FIG. 2 and referring to FIGS. 4A-4G, the first gas flow assembly 16 is positioned on an inner circumference 114 of the rotor 12. The first gas flow assembly 16 includes the plurality of nozzles 102 (FIG. 2) that are removably attached to the inner circumference 114 of the rotor 12. Each nozzle 102 has a nozzle inlet 116, a nozzle outlet 118 and a nozzle channel 120 disposed therebetween (FIGS. 2 and 4A). Specifically, a first stage of gas expansion occurs through a set of nozzles 102 that are mounted or rooted on the inner circumference 114 of the rotor 12, adjacent the axial end wall 58 (FIG. 2) of the rotor 12. The nozzles 102 are illustrated in detail in FIGS. 4A to 4F, and are generally wedge shaped. Each nozzle 102 positions the nozzle inlet 116 in a direction facing radially inward toward the rotor axis “X”. The nozzles 102 are dimensioned and arranged so that openings of the nozzle inlets 116 are in proximity to the heat outlet 84 of the heat assembly 14. The heat assembly 14 directs gas from the heat inlet 82 through the heat channel 86 and out of the heat outlet 84. From the heat outlet 84, the heat assembly 14 directs the heated gas radially into the nozzle inlet 116 wherein the nozzle outlets 118 discharge the heated gas tangentially with respect to the inner circumference 114 of the rotor 12 such that the discharged heated gas produces a reactive force on the nozzles 102 to rotate the rotor 12 about the rotor axis “X”.

The outlet 118 of the nozzles 102 is formed to expel the heated gas from the nozzles 102 substantially in a tangential direction with respect to the circumference 114 of the rotor 12. Hot gas from the outlet 84 of the heat assembly 14 therefore enters the nozzle inlet 116 of the nozzles 102, is expelled from the nozzle outlet 118, and a reactive force is produced on the nozzles 102 which in turn urges the rotor 12 to spin about its axis “X”.

Since the nozzles 102 are removably attached to the inner circumference 114 of the rotor 12, the force that causes compression stress is centrifugal force as a result of rotation caused by the reactive force. (FIG. 4G) As such, the nozzles 102 do not experience tensile stress. In other words, because of their configuration and placement in the turbine 10, the nozzles 102 are subject to reactive and centrifugal forces during operation, the forces being primarily compressive rather than tensile in nature. Since the nozzles 102 undergo little if any tensile stress, the nozzles 102 may be manufactured from ceramic materials.

In the embodiment illustrated in FIG. 4E, the nozzles 102 are constructed and arranged so that the nozzle channels 120 of every two adjacent nozzles 102 combine to form the nozzle outlet 118 from which accelerated hot gas is discharged as a jet substantially in the tangential direction. As such, the nozzles 102 are arranged on the inner circumference 114 of the rotor 12 so that the adjacent nozzles 102 combine to discharge the heated gas in the tangential direction with respect to the inner circumference 114 of the rotor 12. Referring to FIGS. 4B-4D, a pair of oppositely facing hooked roots 122 extend from a radially outer face 124 of each nozzle 102, and the roots 122 are removeably attachable into corresponding axial grooves formed in the inner circumference 114 of the rotor 12 for holding the nozzle 102 in place (FIG. 2). As such, the roots 122 extend from the nozzles 102 wherein the roots 122 removably attach the nozzles 102 to the inner circumference 114 of the rotor 12.

It will be understood that during turbine operation, the rotor 12 is urged to spin about its axis primarily by forces developed as a result of friction between the radially outer faces 124 of the nozzles 102 and the inner circumference 114 of the rotor 12. The friction results from the centrifugal force acting on the nozzles 102. The roots 122 on the outer faces 124 of the nozzles 102 will convey little, if any, rotational force to the rotor 12 at operational speeds. The rotor 12 applies a centrifugal force resulting in friction between the plurality of nozzles 102 and the inner circumference 114 of the rotor 12. As shown in FIG. 2, a retainer ring 126 is seated in a circumferential groove in the inner surface of the rotor 12, wherein the ring 126 maintains the axial position of the nozzles 102 inside the rotor 12.

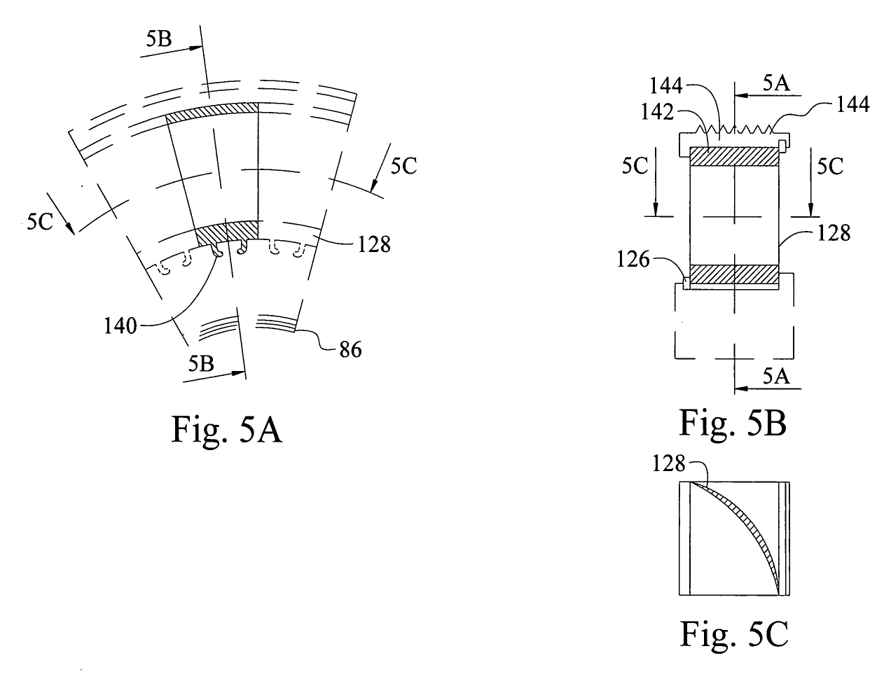

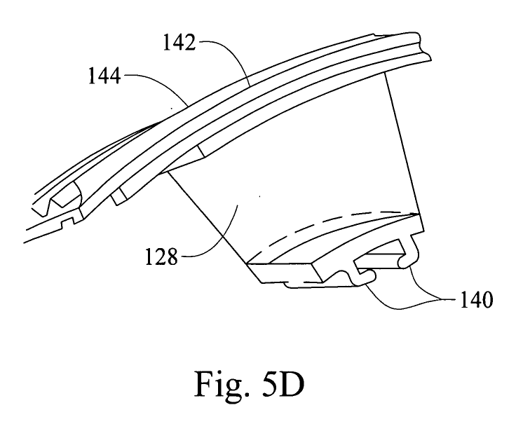

Turning to FIG. 2 and referring to FIGS. 1 and 5A-5D, the second gas flow assembly 22 is positioned on the inner circumference 114 of the rotor 12 and positioned adjacent to the first gas flow assembly 16. In particular, the second gas flow assembly 22 is positioned adjacent the nozzle outlet 118 of the first gas flow assembly 16. The second gas flow assembly 22 includes a plurality of stationary blades 128 fixedly supported on and by the heat assembly 14 and has a plurality of rotary blades 130 removably attached to the inner circumference 114 of the rotor 12. The flow direction of the hot gas jets exiting from the nozzle outlets 118 of the nozzles 102 is altered by the set of second stage stationary blades 128 that are rooted in the outer circumference of a collar 132 that is fixed coaxially on the periphery of the heat channel 86. Preferably, the collars 132 are provided with axial locking key members 138 in order to prevent the collars 132 from rotation about the heat channel 86. In one embodiment, the stationary blades 128 are also formed of ceramics and are illustrated in detail in FIGS. 5A to 5D. The plurality of stationary blades 128 are fixedly supported on the heat assembly 14 in a position to receive the discharged heated gas from the nozzle outlet 118 of the first gas flow assembly 16 and direct the discharge heated gas toward the plurality of rotary blades 130 so the discharged heated gas expands through the plurality of rotary blades 130. The gas then continues to expand in the plurality of rotary blades 130 which are rooted on the inner circumference 114 of the rotor 12. The expanding gas forces the rotary blades 130 to move to further assist rotation of the rotor 12.

As shown in FIG. 5A, the stationary blades 128 have the same basic root configuration as nozzles, i.e., opposed hooked roots 140 at the bases of the blades 128. The blade roots 140 engage corresponding slots formed in the collars fixed on the heat channel 86. The stationary blades 128 are preferably formed with an integral shroud 142 (FIG. 5B). Tip bands 144 preferably encircle the shrouds 142 of each set of the stationary blades 128 thus keeping the blades 128 in position and preventing movement of the blades 128 during turbine operation, and to provide a seal against the inner circumference 114 of the rotor 12. Each tip band 144 features an integral seal for creating a gas seal between the stationary blades and the inner circumference 114 of the rotor 12. In one embodiment, the seal comprises a labyrinth seal. Additionally, the bands 144 and retainer rings 126 (FIGS. 2, 5B and 5D) secure the bands 144 against differential gas pressure forces developed across the stage. The stationary blades 128 may be mounted using configurations other than a double hook, as is known in the art. The force on the stationary blades results from the gas flow and very minor reactive force owing to slight gas expansion.

The nozzles 102 as well as the sets of stationary 128 and rotary blades 130 may be formed individually, or as integral sets of nozzles and blades wherein a number of the nozzles and the blades of each set are formed together so as to facilitate their assembly within the turbine 10.

Cylindrical spacers 150 on the heat channel 86 as shown in FIG. 2, separate the stationary blade collars 132 axially. The axial lengths of the spacers 150 correspond to the axial widths of the second and the third stage rotary blades and should create adequate clearance for rotation of those blades. The spacers 150 preferably have seals against which shrouds of the rotary blades 130 can establish a gas seal during blade rotation. The seals may be formed either integrally with the spacers 150 or on the circumference of renewable bushings 154 that fit concentrically over the spacers.

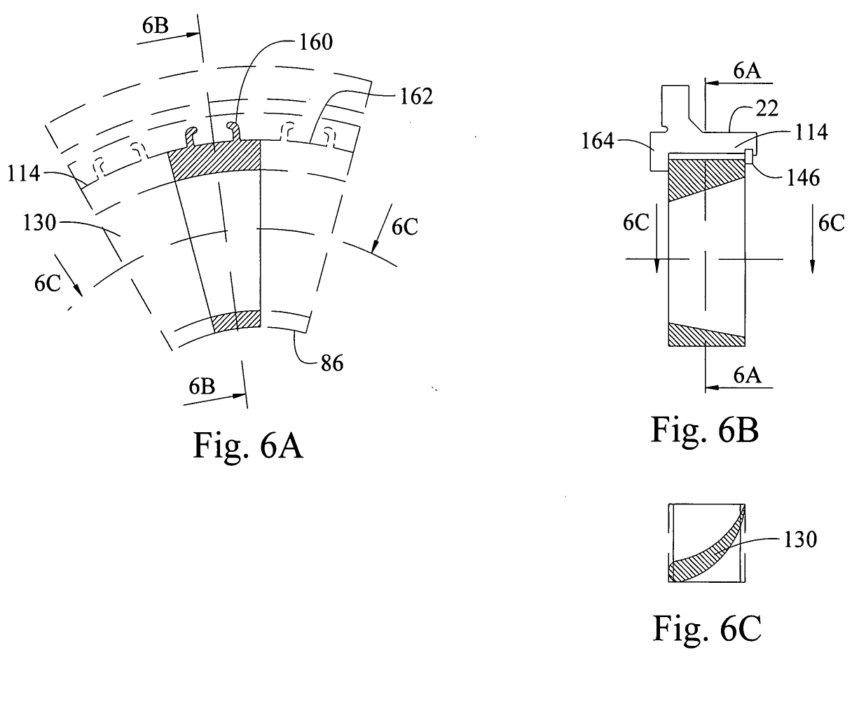

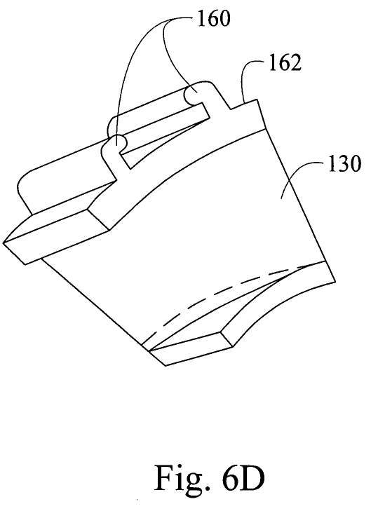

Turning to FIGS. 6A-6C, roots 160 extend from the plurality of rotary blades 130 of the second gas flow assembly wherein these roots 160 removably attach the plurality of blades 130 to the inner circumference 114 of the rotor 12. Retainer rings 126 (FIG. 2) secure the blades 130 to the inner circumference 114. All of the rotary blades 130 transmit the force that causes rotation in the same way as the nozzles 102. The friction between the blades 130 and the inner circumference 114 is induced by centrifugal forces.

The third gas flow assembly 24 (FIG. 8) is positioned on the inner circumference 114 of the rotor 12 and positioned adjacent to the second flow assembly 22. The third gas flow assembly includes another plurality of stationary blades fixedly supported by the heat assembly 14 and having another plurality of rotary blades removably attached to the inner circumference 114 of the rotor 12.

The plurality of stationary blades of the third gas flow assembly are rooted in the outer circumference of a collar that is fixed coaxially on the heat channel 86, and these stationary blades direct the gas to expand further through the other plurality of rotary blades that are rooted on the inner circumference 114 of the rotor 12.

The plurality of stationary blades of the third gas flow assembly are fixedly supported on the heat assembly 14 in a position to receive the discharged heated gas from the second gas flow assembly 22 and direct the discharged heated gas toward the plurality of rotary blades so that the discharged heated gas expands through the other plurality of rotary blades of the third gas flow assembly 24 in order to further assist rotational movement of the rotor 12 about the rotor axis “X”.

The geometries of the blades in the second and the third gas flow assemblies of stationary blades may be similar, although the actual sizes of the blades used for the two stages may differ so as to accommodate the expanding gas flow. The same is true for the geometries of the blades in the second and the third gas flow assemblies of rotary blades.

In the disclosed embodiment of the turbine 10, the hollow rotor 12 is assembled by bolting or otherwise joining the end disc 58, a cylindrical rotor section (i.e., second gas flow assembly 22) and another cylindrical rotor section (i.e., third gas flow assembly 24), in axial alignment with one another. (See FIGS. 1 and 2.) The end disc 58 forms: (i) the axial end wall of the rotor 12 to which the turbine shaft 50 is joined, (ii) the inner circumference 114 region of the hollow rotor on which the first stage nozzles 102 are rooted, and (iii) the inner circumference 114 region of the rotor 12 that extends over the stationary blades 128 of the second gas flow assembly 22 mounted on the heat channel 86 inside the rotor 12. The cylindrical rotor section 22 forms: (i) the inner circumference 114 region of the rotor 12 on which the rotary blades 130 of the second gas flow assembly 22 are rooted, and (ii) the inner circumference 114 region of the rotor 12 that extends over the stationary blades of the third gas flow assembly mounted on the heat channel 86.

Prior to assembly, the second stage rotary blades 130 are mounted inside the cylindrical sections 22 by sliding opposed hook roots 160 (FIG. 6A) that are formed on a radially outer face 162 of each blade, into axial grooves formed in the inner circumference 114 of the corresponding cylindrical sections 22. The blades 130 are secured axially by retaining shoulders 164 and rings 126 (FIG. 6B). The blade roots 160 keep the rotary blades 130 in place when the turbine 10 is at rest and during initial operation. Once the turbine rotor 12 is run up to operating speed, the rotary blades 130 are held in place by centrifugal force which urges the radially outer faces 162 (FIG. 6A) of the blades against the inner circumference 114 of the assembled rotor 12 as the result at the friction force.

The radially inwardly directed shoulder 164 is formed on the gas entrance side of the cylindrical sections 22 (see top of FIGS. 2 and 6B) for supporting the corresponding rotary blades 130 against axial reaction forces. On the gas exit side, the blades 130 are restrained by the retainer rings 126 which are seated in circumferential grooves in the inner circumference 114 of the section 22.

Turning to FIG. 1, an inner diffuser 168, which may be split horizontally, is clamped about the heat channel 86 between a pair of axially spaced support shoulders 170, 172 on the periphery of the heat channel 86. The diffuser 168 faces the exhaust side of the second stage rotary blades 130 and directs exhausted gas radially outward through the exhaust duct 74 that communicates with the heat exchanger 28 (FIG. 3).

The gas turbine configuration described herein may use relatively inexpensive ceramics materials for heat sensitive components, while deleterious effects of high temperature such as corrosion and loss of strength are alleviated. As the nozzles 102 and the stationary blades 128 and the rotary blades 130 are preferably formed of ceramics. Ceramic blades have the advantage of chemical resistance, high thermal stability, low density, chemical inertia, high corrosion resistance, good dimensional stability at high temperatures. Other features include: relatively easy manufacturing, low density, expected lower production cost in comparison with cost of production of metallic blades. Furthermore, ceramic components can be cleaned by chemicals and washing from deposits to maintain efficiency.

A significant advantage of the present disclosure is that tensile stress due to centrifugal force in the nozzles 102 and stages of rotating blades 130 is practically eliminated. The only forces exerted on the blades 130 that produce tensile stress are from the expanding gas that travels past them. The major stresses in the disc and the rings of the rotor are hoop stresses resulting from the centrifugal force of the disc, the rings, and the rotary blades. Ceramics offer another advantage here for their low density resulting in low hoop stress in the rotor cylinders.

Another benefit of the present disclosure with respect to stress levels is intensive rotor cooling that allows the application of less expensive materials. As a result, conventional high temperature resistant steel may be utilized instead of exotic alloys. Stationary components and the rotor may all be cooled with low-pressure air from the cooling assembly 20. The stationary spacers, rings and blades are conduction cooled by way of metal-to-metal contact with the cooled heat channel 86.

The use of low pressure cooling air in the present turbine 10 is significant with respect to increased power output and improved efficiency. In conventional gas turbines, internal complements such as blades, combustor and shaft are cooled with a portion of air taken from the compressor. Such an arrangement consumes up to 5% of high-pressure air. High pressure is required since the combustor and blades are in the stream of high-pressure gas, and cooling air must be discharged against that pressure. The turbine configuration of the present disclosure does not require high-pressure air to be diverted from the output of the compressor in order to achieve adequate cooling. The rotor cooling is accomplished by passing the cooling air outside of the rotor 12, through the cylindrical passage formed by the rotor 12 and enclosed by the hot casing 34 thus avoiding high-pressure hot gas path. The stationary components are cooled directly by passing cooling air inside stationary support, the heat channel 86 and indirectly, by convection between stationary blades collars 132 and heat channel 86. The low-pressure air supply communicates air to the inlet 54 for rotor cooling, and to another air inlet 106 for cooling of stationary components inside the turbine.

The air inlet 54 is provided on the cold casing cover 40 for receiving a supply of low pressure (LP) cooling air. As seen in FIG. 1, the inlet 54 communicates with ring for distributing the cooling air circumferentially to a removable partition 176 that is set inside the covered cold casings 36, 40. The partition 176 is arranged in a separate space enclosed by the covered cold casings 36, 40 from a space enclosed by the covered hot casing 34, 38 to direct low pressure cooling air to heated components inside the hot casing 34 including the turbine rotor 12. The air flows axially in the channel 80 between the outer circumference of the rotor 12 and the inner periphery of the covered hot casing 34, 38 and exits through exhaust duct 74.

Referring to FIGS. 1-3, with the exception of the second gas flow assembly, the assembly process preferably begins by assembling all components that rotate, namely, the shaft 50, start-up gear 56, compressor 30, bearing assembly 52, and the gas turbine rotor 12. The rotor 12 is assembled with all its components, namely, the disc with nozzles 102, the cylindrical rotor sections 22 with the second rotary blades 130.

The stationary parts are assembled outside of the hot casing 34. The collars 132 are prepared with the stationary blades 128 and associated tip bands 144. The heat assembly 14 is constructed from the internally grooved heat channel 86, the metallic inert tube 94 and the interior ceramic liner tube 96. If the axial spacers 150 use the consumable labyrinth seal bushings 154, the bushings are also installed. The spacer under any third stage rotary blades is set next to the annular shoulder 170 on the circumference of the heat assembly 14, and the complete additional stage, i.e., the bladed second stage rotor section is set to rest freely on the spacer.

Next, the complete, second stage stationary bladed collar is placed onto the heat assembly 14 next to the spacer, and the spacer 150 is placed next to the collar on the heat assembly 14. The complete, bladed second stage rotor section 22 is then set to rest freely on the spacer 150, and the second stage stationary bladed collar 132 is placed on the heat assembly 14 next to the spacer 150. The gas seal 98 is installed at the outlet end 84 of the heat assembly 14, followed by a bayonet or equivalent lock ring 152. During turbine operation, gas forces resulting from declining pressures acting on the stationary sets of blades 128 are directed axially toward the right in FIGS. 1 & 2, so that the shoulder 170 on the heat channel 86 restrains axial displacement of the stationary blades 130.

The assembled stationary components and the rotor sections 22 with the rotary blades 130 rooted therein, are set into the hot casing 34 and the support cover 112 is fixed. The hot casing 34 and the cold casing 36 are then mated and bolted to one another. At this time, the rotor section 22 including the rooted rotary blades is resting freely on the corresponding spacers 150.

The rotor sections 22 and the rotor disc are mated together with the aid of locating pins, and are then bolted to one another so that the rotor 12 is now fully assembled and properly balanced. Next, the hot casing 34 and cold casings 40 are bolted together and than hot and cold casing covers 38, 40 are fastened to the respective casings. Accordingly, the first gas flow assembly 16 and second gas flow assembly 22 are axially arranged from end to end and around the rotor 12.

The configuration can be used as well with conventional, metallic materials; the benefit here is owing to elimination of blade roots and associated stress problems. A significant benefit results from the rotor cooling and its affect on the blades by means of convection heat transfer.

In view of the above, it will be seen that the several objects of the disclosure are achieved and other advantageous results are obtained. As various changes could be made in the above constructions without departing from the scope of the disclosure, it is intended that all matter contained in the above description or shown in the accompanying drawings shall be interpreted as illustrative and not in a limiting sense.

1. A rotor assembly for a turbine that has a rotor supported in a turbine compressor casing of the turbine for rotational movement of the rotor about a rotor axis, comprising:
a first gas flow assembly positioned within the turbine compressor casing and around the rotor, the first gas flow assembly having a plurality of nozzles that are removeably attached to an inner circumference of the rotor, each nozzle having a nozzle inlet, a nozzle outlet and a nozzle blade disposed there between;
a heat assembly partially positioned within the turbine compressor casing of the rotor, the heat assembly having a heat inlet positioned outside of the rotor, a heat outlet in communication with the nozzle inlet and a heat channel disposed between the heat inlet and the heat outlet, the heat assembly directing heated gas from the heat inlet to the heat outlet and radially into the nozzle inlet wherein the nozzle outlets discharge the heated gas tangentially with respect to the rotor such that the discharged heated gas produces a reactive force on the plurality of nozzles to rotate the rotor about the rotor axis; and
a second gas flow assembly positioned on the inner circumference of the rotor and positioned adjacent to the first gas flow assembly, the second gas flow assembly having a plurality of stationary blades fixedly supported on the heat assembly and having a plurality of rotary blades removeably attached to the inner circumference of the rotor.

2. The rotor assembly of claim 1 further comprising a cooling assembly portion positioned in fluid communication with the turbine compressor casing, the cooling assembly having a fluid inlet, a fluid outlet and a fluid channel there between, the fluid channel being positioned around the first gas flow assembly to direct cooling fluid around the first gas flow assembly.

3. The rotor assembly of claim 2 wherein the cooling fluid comprises low-pressure air.

4. The rotor assembly according to claim 1 wherein the plurality of nozzles are arranged on the inner circumference of the rotor so that two adjacent nozzles combine to discharge the heated gas in the tangential direction with respect to the rotor.

5. The rotor assembly of claim 1 further comprising roots extending from the plurality of nozzles wherein the roots removeably attach the nozzles to the inner circumference of the rotor.

6. The rotor assembly of claim 2 wherein the heat assembly further comprises a plurality of cooling fluid channels axially positioned within the heat channel wherein the plurality of cooling channels circulate cooling fluid within the heat channel.

7. The rotor assembly of claim 6 further comprising a source of low pressure cooling fluid wherein the source is common to the cooling assembly and the heat assembly.

8. The rotor assembly of claim 1 wherein the heat channel directs the heated gas within the rotor.

9. The rotor assembly of claim 1 wherein the plurality of stationary blades are fixedly supported on the heat assembly in a position to receive the discharged heated gas from the nozzle outlet and direct the discharged heated gas toward the plurality rotary blades so the discharged heated gas expands through the plurality of rotary blades.

10. The rotor assembly of claim 9 wherein the rotor applies a centrifugal force resulting in friction between the plurality of rotor blades and the inner circumference of the rotor.

11. The rotor assembly of claim 1 wherein the plurality of stationary blades has a shroud and an associated seal on the shroud to create a seal between the plurality of stationary blades and the inner circumference of the rotor.

12. The rotor assembly of claim 1 wherein the nozzles and the plurality of blades comprise a ceramic material.

13. The rotor assembly of claim 1 further comprising roots that extend from the plurality of rotary blades wherein the roots removeably attach the plurality of blades to the inner circumference of the rotor.

14. The rotor assembly of claim 1 wherein the first gas flow assembly and the second gas flow assembly are axially arranged from end to end and around the rotor.

15. A rotor assembly for a turbine that has a rotor supported in a turbine compressor casing of the turbine for rotational movement of the rotor about a rotor axis, comprising:
a first gas flow assembly positioned on an inner circumference of the rotor, the first gas flow assembly having a plurality of ceramic nozzles that are removeably attached to an inner circumference of the rotor, each nozzle having a nozzle inlet, a nozzle outlet and a nozzle blade disposed there between;
a cooling assembly positioned in fluid communication with the turbine compressor casing, the cooling assembly having a fluid inlet, a fluid outlet and a fluid channel there between, the fluid channel being positioned around the turbine compressor casing which surrounds the first gas flow assembly and the second gas flow assembly;
a heat assembly partially positioned within the turbine compressor casing, the heat assembly having a heat inlet positioned outside of the turbine compressor casing, a heat outlet in communication with the nozzle inlet and a heat channel disposed between the heat inlet and the heat outlet, the heat assembly directing heated gas from the heat inlet to the heat outlet and radially into the nozzle inlet wherein the nozzle outlets discharge the heated gas tangentially with respect to the rotor such that the discharged gas produces a reactive force on the plurality of ceramic nozzles to rotate the rotor about the rotor axis; and
a second gas flow assembly positioned on the inner circumference of the rotor and positioned adjacent to the first gas flow assembly, the second gas flow assembly having a plurality of stationary blades fixedly supported on the heat assembly and having a plurality of ceramic rotary blades removeably attached to the inner circumference of the rotor, the plurality of stationary blades are fixedly supported on the heat assembly in a position to receive the discharged heated gas from the nozzle outlet and direct the discharged heated gas toward the rotary blades so the discharged heated gas expands through the plurality of ceramic rotary blades to further rotate the rotor about the rotor axis.

16. The rotor assembly of claim 15 wherein the heat assembly further comprises a plurality of cooling fluid channels axially positioned around the heat channel wherein the plurality of cooling channels circulate air within the heat channel.

17. The rotor assembly of claim 15 further comprising roots that extend from the ceramic nozzles and the plurality of ceramic rotary blades wherein the roots removeably attach the ceramic nozzles and the plurality of ceramic rotary blades to the inner circumference of the rotor.

18. A turbine system, comprising:
a turbine that has a rotor supported in a turbine compressor casing of the turbine for rotational movement of the rotor about a rotor axis;
a first gas flow assembly positioned on an inner circumference of the rotor, the first gas flow assembly having a plurality of ceramic nozzles that are removeably attached to the inner circumference of the rotor, each ceramic nozzle having a nozzle inlet, a nozzle outlet and a nozzle blade disposed there between;
a cooling assembly positioned in fluid communication with the turbine compressor casing, the cooling assembly having a fluid inlet, a fluid outlet and a fluid channel there between, the fluid channel being positioned within the turbine compressor casing which surrounds the first gas flow assembly;
a combustor operatively connected to the turbine, the combustor having a fuel inlet and a gas outlet; and
a heat assembly partially positioned within the turbine compressor casing, the heat assembly having a heat inlet connected the gas outlet, a heat outlet in communication with the nozzle inlet and a heat channel disposed between the heat inlet and the heat outlet, the heat assembly directing heated gas supplied by the combustor to the heat outlet and radially into the nozzle inlet wherein the nozzle outlets discharge the heated gas tangentially with respect to the rotor such that the discharged heated gas produces a reactive force on the plurality of ceramic nozzles to rotate the rotor about the rotor axis.

19. The turbine system of claim 18 further comprising a second gas flow assembly positioned on the inner circumference of the rotor and positioned adjacent to the first gas flow assembly, the second gas flow assembly having a plurality of stationary blades fixedly supported on the heat assembly and having a plurality of rotary blades removeably attached to the inner circumference of the rotor wherein the plurality of stationary blades are fixedly supported on the heat assembly in a position to receive the discharged heated gas from the nozzle outlet and direct the discharged heated gas toward the rotary blades so the discharged heated gas expands through the plurality of rotary blades to generate a reactive force to cause rotation of the rotor.

20. The turbine system of claim 18 wherein the fluid channel is positioned within the turbine compressor casing which surrounds the second gas flow assembly.
